(19) United States
(12) Patent Application Publication
(10) Pub. No.: US 2012/0286194 A1
(43) Pub. Date: Nov. 15, 2012

(54) THERMAL CONDUCTIVE SHEET, INSULATING SHEET, AND HEAT DISSIPATING MEMBER

(75) Inventor: Keisuke HIRANO, Osaka (JP)

(73) Assignee: NITTO DENKO CORPORATION, Osaka (JP)

(21) Appl. No.: 13/469,982

(22) Filed: May 11, 2012

(30) Foreign Application Priority Data
May 13, 2011 (JP) 2011-108584

(51) Int. Cl. C09K 5/14

(52) U.S. Cl. 252/73

(57) ABSTRACT

A thermal conductive sheet contains a resin and a filler. The filler contains a plate-like or flake-like first filler and a block-like or sphere-like second filler, and the average orientation angle of the first filler is 28 degrees or more and the maximum orientation angle thereof is 60 degrees or more with respect to the plane direction of the thermal conductive sheet.

### CROSS-REFERENCE TO RELATED APPLICATION

The present application claims priority from Japanese Patent Application No. 2011-108584 filed on May 13, 2011, the contents of which are hereby incorporated by reference into this application.

### BACKGROUND OF THE INVENTION

1. Field of the Invention

The present invention relates to a thermal conductive sheet, an insulating sheet, and a heat dissipating member, to be specific, to a thermal conductive sheet for use in power electronics technology and the like, an insulating sheet and a heat dissipating member obtained by using the thermal conductive sheet.

2. Description of Related Art

In recent years, power electronics technology which uses semiconductor elements to convert and control electric power is applied in hybrid devices, high-brightness LED devices, and electromagnetic induction heating devices. In power electronics technology, a high current is converted to, for example, heat, and therefore materials that are disposed near the semiconductor element are required to have excellent heat dissipation characteristics (excellent heat conductivity) and insulating characteristics.

A thermal conductive sheet obtained by dispersing, for example, an inorganic filler having thermal conductivity and insulating characteristics, a flake-like boron nitride, and the like in a resin has been known.

The flake-like boron nitride has a high thermal conductivity in the longitudinal direction and a low thermal conductivity in the short-side direction. Therefore, for example, when the longitudinal direction of the boron nitride is allowed to be along the thickness direction of the thermal conductive sheet, the thermal conductivity in the thickness direction can be improved. Also, when the longitudinal direction of the boron nitride is allowed to be along the plane direction of the thermal conductive sheet, the thermal conductivity in the plane direction can be improved.

However, there is a disadvantage that, when the thermal conductive sheet is produced by press molding or roll forming, the boron nitride tends to be along the plane direction of the thermal conductive sheet, so that the obtained thermal conductive sheet has a poor thermal conductivity in the thickness direction, while having an excellent thermal conductivity in the plane direction.

On the other hand, there are cases where the thermal conductive sheet is required to have an excellent thermal conductivity not only in the plane direction but also in the thickness direction depending on its use.

Therefore, for example, a thermal conductive sheet, which is obtained by dispersing secondary aggregated particles having a porosity of 50% or less and an average pore size of 0.05 to 3 μm obtained by aggregating primary particles of the boron nitride in a thermosetting resin, has been proposed (ref: for example, Japanese Unexamined Patent Publication No. 2010-157563).

In the thermal conductive sheet, the boron nitride is contained as the secondary aggregated particles, that is, contained without being oriented in the thickness direction or the plane direction of the thermal conductive sheet, so that the thermal conductivity in the thickness direction and the plane direction can be ensured.

### SUMMARY OF THE INVENTION

However, there is a disadvantage that to obtain the thermal conductive sheet described in Japanese Unexamined Patent Publication No. 2010-157563, production of the secondary aggregated particles of the boron nitride is required, so that a complicated process such that the boron nitride is temporarily calcined at high temperature and pulverized to be in a slurry state and then is calcined is required.

It is an object of the present invention to provide a thermal conductive sheet capable of being obtained with an easy operation and having an excellent thermal conductivity in the thickness and plane directions, and an insulating sheet and a heat dissipating member obtained by using the thermal conductive sheet.

A thermal conductive sheet of the present invention contains a resin and a filler, wherein the filler contains a plate-like or flake-like first filler and a block-like or sphere-like second filler, and the average orientation angle of the first filler is 28 degrees or more and the maximum orientation angle thereof is 60 degrees or more with respect to the plane direction of the thermal conductive sheet.

In the thermal conductive sheet of the present invention, it is preferable that the ratio of the first filler having an orientation angle of 30 degrees or more with respect to the plane direction of the thermal conductive sheet is 20% or more with respect to the total amount of the first filler in the conversion of number frequency.

In the thermal conductive sheet of the present invention, it is preferable that the first filler has an average particle size of 30 to 100 μm and the second filler has an average particle size of 20 to 80 μm, and the first filler content is 30 to 95 parts by mass and the second filler content is 5 to 70 parts by mass with respect to 100 parts by mass of the total amount of the first filler and the second filler.

In the thermal conductive sheet of the present invention, it is preferable that the filler content is 50 to 95 parts by mass with respect to 100 parts by mass of the total amount of the thermal conductive sheet.

An insulating sheet of the present invention is obtained by using a thermal conductive sheet, wherein the thermal conductive sheet contains a resin and a filler; the filler contains a plate-like or flake-like first filler and a block-like or sphere-like second filler; and the average orientation angle of the first filler is 28 degrees or more and the maximum orientation angle thereof is 60 degrees or more with respect to the plane direction of the thermal conductive sheet.

A heat dissipating member of the present invention is obtained by using a thermal conductive sheet, wherein the thermal conductive sheet contains a resin and a filler; the filler contains a plate-like or flake-like first filler and a block-like or sphere-like second filler; and the average orientation angle of the first filler is 28 degrees or more and the maximum orientation angle thereof is 60 degrees or more with respect to the plane direction of the thermal conductive sheet.

In the thermal conductive sheet, the insulating sheet, and the heat dissipating member of the present invention, the filler contains the plate-like or flake-like first filler and the block-like or sphere-like second filler, and the first filler is contained so that the average orientation angle thereof is 28 degrees or more and the maximum orientation angle thereof is 60 degrees or more with respect to the plane direction of the thermal conductive sheet. Therefore, the thermal conductivity in the thickness and plane directions of the thermal conductive sheet can be ensured.

Thus, the thermal conductive sheet, the insulating sheet, and the heat dissipating member of the present invention can be used for various applications as a thermal conductive sheet, an insulating sheet, and a heat dissipating member having an excellent thermal conductivity in the thickness and plane directions.

### BRIEF DESCRIPTION OF THE DRAWINGS

FIG. 1 shows a perspective view of one embodiment of a thermal conductive sheet of the present invention.

FIG. 2 shows an X-ray CT image of the thermal conductive sheet of Example 1.

FIG. 3 shows a histogram of an orientation angle obtained by analyzing the X-ray CT image of the thermal conductive sheet of Example 1.

FIG. 4 shows an X-ray CT image of the thermal conductive sheet of Example 4.

FIG. 5 shows a histogram of an orientation angle obtained by analyzing the X-ray CT image of the thermal conductive sheet of Example 4.

FIG. 6 shows an X-ray CT image of the thermal conductive sheet of Comparative Example 1.

FIG. 7 shows a histogram of an orientation angle obtained by analyzing the X-ray CT image of the thermal conductive sheet of Comparative Example 1.

### DETAILED DESCRIPTION OF THE INVENTION

A thermal conductive sheet of the present invention contains a resin and a filler.

The resin is a component that is capable of dispersing the filler, that is, a dispersion medium (matrix) in which the filler is dispersed, including, for example, a thermosetting resin and a thermoplastic resin.

Examples of the thermosetting resin include epoxy resin, thermosetting polyimide, phenol resin, urea resin, melamine resin, unsaturated polyester resin, diallyl phthalate resin, silicone resin, and thermosetting urethane resin.

Examples of the thermoplastic resin include polyolefin (for example, polyethylene, polypropylene, and ethylene-propylene copolymer), acrylic resin (for example, polymethyl methacrylate), polyvinyl acetate, ethylene-vinyl acetate copolymer, polyvinyl chloride, polystyrene, polyacrylonitrile, polyamide (nylon (trade mark)), polycarbonate, polyacetal, polyethylene terephthalate, polyphenylene oxide, polyphenylene sulfide, polysulfone, polyether sulfone, poly ether ether ketone, polyallyl sulfone, thermoplastic polyimide, thermoplastic urethane resin, polyamino-bismaleimide, polyamide-imide, polyether-imide, bismaleimide-triazine resin, polymethylpentene, fluorine resin, liquid crystal polymer, olefin-vinyl alcohol copolymer, ionomer, polyarylate, acrylonitrile-ethylene-styrene copolymer, acrylonitrile-butadiene-styrene copolymer, and acrylonitrile-styrene copolymer.

A preferable example of the thermosetting resin is epoxy resin.

The epoxy resin is in a state of liquid, semi-solid, or solid under normal temperature.

To be specific, examples of the epoxy resin include aromatic epoxy resins such as bisphenol epoxy resin (for example, bisphenol A epoxy resin, bisphenol F epoxy resin, bisphenol S epoxy resin, hydrogenated bisphenol A epoxy resin, dimer acid-modified bisphenol epoxy resin, and the like), novolak epoxy resin (for example, phenol novolak epoxy resin, cresol novolak epoxy resin, biphenyl epoxy resin, and the like), naphthalene epoxy resin, fluorene epoxy resin (for example, bisaryl fluorene epoxy resin and the like), and triphenylmethane epoxy resin (for example, trishydroxyphenylmethane epoxy resin and the like); nitrogen-containing-cyclic epoxy resins such as triepoxypropyl isocyanurate (triglycidyl isocyanurate) and hydantoin epoxy resin; aliphatic epoxy resin; alicyclic epoxy resin (for example, dicyclo ring-type epoxy resin and the like); glycidylether epoxy resin; and glycidylamine epoxy resin.

These epoxy resins can be used alone or in combination of two or more.

As the epoxy resin, for example, a combination of an epoxy resin that is liquid under normal temperature and an epoxy resin that is solid under normal temperature is used.

The epoxy resin has an epoxy equivalent of, for example, 100 to 1000 g/eqiv., or preferably 150 to 700 g/eqiv., and has a softening temperature (ring and ball test) of, for example, 80° C. or less (to be specific, 20 to 80° C.), or preferably 70° C. or less (to be specific, 35 to 70° C.).

The epoxy resin has a melt viscosity at 80° C. of, for example, 10 to 20000 mPa·s, or preferably 50 to 10000 mPa·s.

The epoxy resin can also be prepared as an epoxy resin composition containing, for example, an epoxy resin, a curing agent, and a curing accelerator.

The curing agent is a latent curing agent (epoxy resin curing agent) that can cure the epoxy resin by heating, and examples thereof include an imidazole compound, an amine compound, an acid anhydride compound, an amide compound, a hydrazide compound, and an imidazoline compound. In addition to the above-described compounds, a phenol compound, a urea compound, and a polysulfide compound can also be used.

Examples of the imidazole compound include 2-phenyl imidazole, 2-methyl imidazole, 2-ethyl-4-methyl imidazole, and 2-phenyl-4-methyl-5-hydroxymethyl imidazole.

Examples of the amine compound include aliphatic polyamines such as ethylene diamine, propylene diamine, diethylene triamine, and triethylene tetramine; and aromatic polyamines such as metha phenylenediamine, diaminodiphenyl methane, and diaminodiphenyl sulfone.

Examples of the acid anhydride compound include phthalic anhydride, maleic anhydride, tetrahydrophthalic anhydride, hexahydrophthalic anhydride, 4-methyl-hexahydrophthalic anhydride, methyl nadic anhydride, pyromelletic anhydride, dodecenylsuccinic anhydride, dichloro succinic anhydride, benzophenone tetracarboxylic anhydride, and chlorendic anhydride.

Examples of the amide compound include dicyandiamide and polyamide.

An example of the hydrazide compound includes adipic acid dihydrazide.

Examples of the imidazoline compound include methylimidazoline, 2-ethyl-4-methylimidazoline, ethylimidazoline, isopropylimidazoline, 2,4-dimethylimidazoline, phenylimidazoline, undecylimidazoline, heptadecylimidazoline, and 2-phenyl-4-methylimidazoline.

These curing agents can be used alone or in combination of two or more.

A preferable example of the curing agent is an imidazole compound.

Examples of the curing accelerator include tertiary amine compounds such as triethylenediamine and tri-2,4,6-dimethylaminomethylphenol; phosphorus compounds such as triphenylphosphine, tetraphenylphosphoniumtetraphenylborate, and tetra-n-butylphosphonium-o,o-diethylphosphorodithioate; a quaternary ammonium salt compound; an organic metal salt compound; and derivatives thereof. These curing accelerators can be used alone or in combination of two or more.

In the epoxy resin composition, the mixing ratio of the curing agent is, for example, 0.5 to 50 parts by mass, or preferably 1 to 10 parts by mass with respect to 100 parts by mass of the epoxy resin, and the mixing ratio of the curing accelerator is, for example, 0.1 to 10 parts by mass, or preferably 0.2 to 5 parts by mass with respect to 100 parts by mass of the epoxy resin.

The above-described curing agent, and/or the curing accelerator can be prepared and used, as necessary, as a solution, that is, the curing agent and/or the curing accelerator dissolved in a solvent; and/or as a dispersion liquid, that is, the curing agent and/or the curing accelerator dispersed in a solvent.

Examples of the solvent include organic solvents including ketones such as acetone and methyl ethyl ketone, esters such as ethyl acetate, and amides such as N,N-dimethylformamide (DMF). Examples of the solvent also include aqueous solvents including water, and alcohols such as methanol, ethanol, propanol, and isopropanol. A preferable example is an organic solvent, and more preferable examples are ketones and amides.

A preferable example of the thermoplastic resins is polyolefin.

Preferable examples of polyolefin are polyethylene and ethylene-propylene copolymer.

Examples of polyethylene include a low density polyethylene and a high density polyethylene.

Examples of ethylene-propylene copolymer include a random copolymer, a block copolymer, or a graft copolymer of ethylene and propylene.

These polyolefins can be used alone or in combination of two or more.

The polyolefins have a weight average molecular weight and/or a number average molecular weight of, for example, 1000 to 10000.

The polyolefin can be used alone or in combination of two or more.

In the resin, in addition to the above-described components (polymer), for example, a polymer precursor (for example, a low molecular weight polymer including oligomer), and/or a monomer are contained.

These resins can be used alone or in combination of two or more.

A preferable example of the resin includes the thermosetting resin.

The resin has a kinetic viscosity as measured in conformity with the kinetic viscosity test of JIS K 7233 (bubble viscometer method) (1986) (temperature: 25° C.±0.5° C., solvent: butyl carbitol, resin (solid content) concentration: 40 mass %) of, for example, 0.22×10⁻⁴ to 2.00×10⁻⁴ m²/s, preferably 0.3×10⁻⁴ to 1.9×10⁻⁴ m²/s, or more preferably 0.4×10⁻⁴ to 1.8×10⁻⁴ m²/s. The above-described kinetic viscosity can also be set to, for example, 0.22×10⁻⁴ to 1.00×10⁻⁴ m²/s, preferably 0.3×10⁻⁴ to 0.9×10⁻⁴ m²/s, or more preferably 0.4×10⁻⁴ to 0.8×10⁻⁴ m²/s.

In the kinetic viscosity test in conformity with JIS K 7233 (bubble viscometer method) (1986), the kinetic viscosity of the resin is measured by comparing the bubble rising speed of a resin sample with the bubble rising speed of criterion samples (having a known kinetic viscosity), and determining the kinetic viscosity of the criterion sample having a matching rising speed to be the kinetic viscosity of the resin.

An example of the filler (including a first filler and a second filler to be described later) includes inorganic particles. Examples of the inorganic particles include carbide, nitride, oxide, hydroxide, metal, and carbonaceous materials.

Examples of the carbide include silicon carbide, boron carbide, aluminum carbide, titanium carbide, and tungsten carbide.

Examples of the nitride include silicon nitride, boron nitride, aluminum nitride, gallium nitride, chromium nitride, tungsten nitride, magnesium nitride, molybdenum nitride, and lithium nitride.

Examples of the oxide include iron oxide, silicon oxide (silica), aluminum oxide (alumina) (including a hydrate of aluminum oxide (boehmite and the like)), magnesium oxide (magnesia), titanium oxide (titania), cerium oxide (ceria), and zirconium oxide (zirconia). Examples of the oxide also include transition metal oxide such as barium titanate and furthermore, indium tin oxide and antimony tin oxide obtained by doping a metal ion thereto.

Examples of the hydroxide include aluminum hydroxide, calcium hydroxide, and magnesium hydroxide.

Examples of the metal include copper, gold, nickel, tin, iron, or alloys thereof.

Examples of the carbonaceous material include carbon black, graphite, diamond, fullerene, a carbon nanotube, a carbon nanofiber, a nanohorn, a carbon microcoil, and a nanocoil.

The inorganic particles may be, in view of fluidity thereof, subjected to a surface treatment by a known method with a silane coupling agent or the like as required.

Examples of the shape of the filler include a plate-like shape, a flake-like shape, a sphere-like shape, and a block-like shape in accordance with the producing method or the crystal structure thereof. In the present invention, a plate-like or flake-like filler is defined as the first filler and a sphere-like or block-like filler is defined as the second filler.

The filler contains the plate-like or flake-like first filler and the block-like or sphere-like second filler.

An example of the first filler includes the above-described plate-like or flake-like inorganic particles. To be specific, examples of the first filler include boron nitride (in a plate-like shape) and aluminum oxide monohydrate (boehmite) (in a plate-like shape).

These first fillers can be used alone or in combination of two or more.

The average particle size (the length in the longitudinal direction) of the first filler as measured by the light scattering method is, for example, 1 to 300 μm, preferably 10 to 200 μm, or more preferably 30 to 100 μm.

The length in the short-side direction of the first filler is, for example, 1 to 300 μm, or preferably 10 to 200 μm. The aspect ratio (the length in the longitudinal direction/the length in the short-side direction) of the first filler is, for example, 100 to 10, or preferably 100 to 20.

The average particle size as measured by the light scattering method is a volume average particle size measured with a dynamic light scattering type particle size distribution analyzer.

As the first filler, a commercially available product or processed goods thereof can be used.

An example of the commercially available product includes a commercially available product of the boron nitride. Examples thereof include the “PT” series (for example, “PT-110”) manufactured by Momentive Performance Materials Inc., and the “SHOBN®UHP” series (for example, “SHOBN®UHP-1”) manufactured by Showa Denko K.K.

An example of the second filler includes the above-described block-like or sphere-like inorganic particles. To be specific, examples of the second filler include aluminum oxide (alumina) (in a sphere-like shape), aluminum hydroxide (in a block-like shape), and silicon oxide (silica) (in a sphere-like shape).

These second fillers can be used alone or in combination of two or more.

The average particle size of the second filler as measured by the light scattering method is, for example, 10 to 100 μm, preferably 20 to 80 μm, or more preferably 20 to 70 μm.

As the second filler, a commercially available product or processed goods thereof can be used.

Examples of the commercially available product include a commercially available product of the aluminum hydroxide and a commercially available product of the aluminum oxide. An example of the commercially available product of the aluminum hydroxide includes the “H” series (for example, “H-10” and “H-10ME”) manufactured by Showa Denko K.K. An example of the commercially available product of the aluminum oxide includes the “AS” series (for example, “AS-10”) manufactured by Showa Denko K.K.

The content ratio of the filler is, for example, 30 to 90 parts by mass, preferably 50 to 90 parts by mass, or more preferably 60 to 90 parts by mass with respect to 100 parts by mass of the total amount of the thermal conductive sheet.

When the content ratio of the filler is within the above-described range, an excellent thermal conductivity can be given.

In the filler, the content ratio of the first filler and the second filler with respect to 100 parts by mass of the total amount of the first filler and the second filler is as follows: the first filler is, for example, 10 to 95 parts by mass, preferably 30 to 95 parts by mass, or more preferably 40 to 90 parts by mass and the second filler is, for example, 5 to 90 parts by mass, preferably 5 to 70 parts by mass, or more preferably 10 to 50 parts by mass.

When the content ratio of the first filler and the second filler is within the above-described range, an excellent thermal conductivity can be given to the thermal conductive sheet in both the thickness and the plane directions.

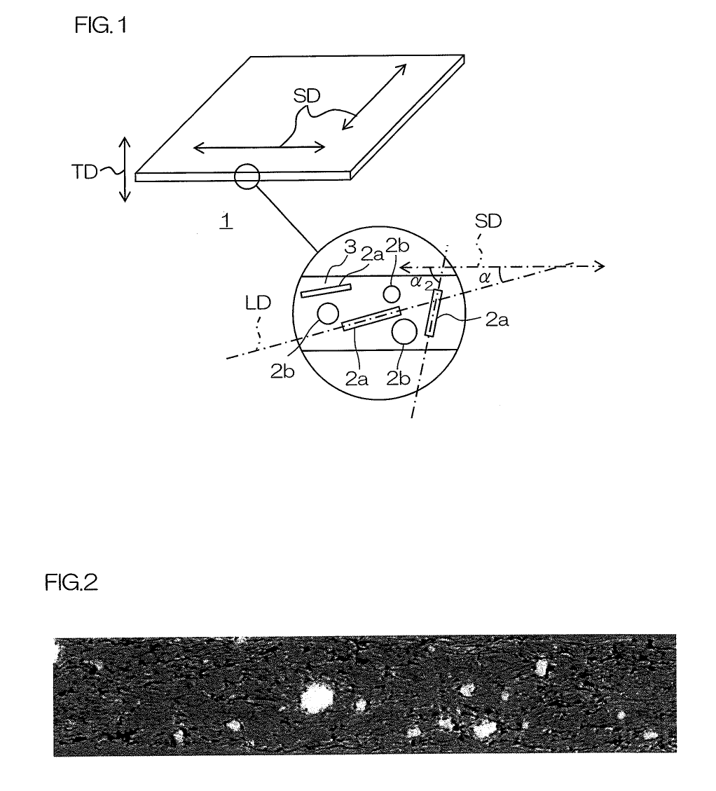

FIG. 1 shows a perspective view of one embodiment of a thermal conductive sheet of the present invention.

Next, a method for producing one embodiment of the thermal conductive sheet of the present invention is described with reference to FIG. 1.

In this method, first, the above-described components (a first filler 2a, a second filler 2b, and a resin 3) are blended at the above-described mixing ratio and are stirred and mixed, thereby preparing a mixture.

In the stirring and mixing, in order to mix the components efficiently, for example, the solvent can be blended therein with the above-described components, or, for example, the resin (preferably, the thermoplastic resin) can be melted by heating.

Examples of the solvent include the above-described organic solvents. When the above-described curing agent and/or the curing accelerator are prepared as a solvent solution and/or a solvent dispersion liquid, the solvent of the solvent solution and/or the solvent dispersion liquid can also serve as a mixing solvent for the stirring and mixing without adding a solvent during the stirring and mixing. Or, in the stirring and mixing, a solvent can further be added as a mixing solvent.

In the case when the stirring and mixing is performed using a solvent, the solvent is removed after the stirring and mixing.

To remove the solvent, for example, the mixture is allowed to stand at room temperature for 1 to 48 hours; heated at 40 to 100° C. for 0.5 to 3 hours; or heated under a reduced pressure atmosphere of, for example, 0.001 to 50 kPa, at 20 to 60° C., for 0.5 to 3 hours.

When the resin (preferably, the thermoplastic resin) is to be melted by heating, the heating temperature is, for example, a temperature in the neighborhood of or exceeding the softening temperature of the resin, to be specific, 40 to 150° C., or preferably 70 to 150° C.

Next, in this method, the obtained mixture is hot-pressed.

To be specific, as necessary, for example, the mixture is hot-pressed with two releasing films (not shown) sandwiching the mixture, thereby producing a pressed sheet (a thermal conductive sheet 1). Conditions for the hot-pressing are as follows: a temperature of, for example, 50 to 150° C., or preferably 60 to 150° C.; a pressure of, for example, 1 to 100 MPa, or preferably 5 to 50 MPa; and a duration of, for example, 0.1 to 100 minutes, or preferably 1 to 10 minutes.

More preferably, the mixture is hot-pressed under vacuum. The degree of vacuum in the vacuum hot-pressing is, for example, 1 to 100 Pa, or preferably 5 to 50 Pa, and the temperature, the pressure, and the duration are the same as those described above for the hot-pressing.

When the resin 3 is the thermosetting resin, the thermal conductive sheet 1 can be cured by heating. To cure the thermal conductive sheet 1, the above-described hot-pressing or a dryer is used. Conditions for the curing by heat are as follows: a temperature of, for example, 60 to 250° C., or preferably 80 to 200° C. and a pressure of, for example, 100 MPa or less, or preferably 50 MPa or less.

In this method, by one time hot-pressing, the temperature can be increased to the softening temperature of the second resin or more. In addition, by one time hot-pressing, the thermal conductive sheet 1 can be cured.

The thickness of the obtained thermal conductive sheet 1 is, for example, 1 mm or less, or preferably 0.8 mm or less, and usually, for example, 0.05 mm or more, or preferably 0.1 mm or more.

In the thermal conductive sheet 1 thus obtained, as shown in FIG. 1 and its partially enlarged schematic view, the first filler 2a is contained such that a longitudinal direction LD thereof forms a predetermined angle (an orientation angle α) with respect to a plane (surface) direction SD that crosses (is perpendicular to) a thickness direction TD of the thermal conductive sheet 1.

The calculated average (an average orientation angle α₁) of the orientation angle α formed between the longitudinal direction LD of the first filler 2a and the plane direction SD of the thermal conductive sheet 1 is 28 degrees or more, preferably 29 degrees or more, or more preferably 30 degrees or more, and usually is less than 90 degrees.

The maximum value (a maximum orientation angle α₂) of the orientation angle α formed between the longitudinal direction LD of the first filler 2a and the plane direction SD of the thermal conductive sheet 1 is 60 degrees or more, preferably 70 degrees or more, or more preferably 74 degrees or more, and usually is less than 90 degrees.

When the average orientation angle α₁ of the first filler 2a with respect to the plane direction SD of the thermal conductive sheet 1 is within the above-described range and the maximum orientation angle α₂ is within the above-described range, an excellent thermal conductivity can be given to the thermal conductive sheet in both the thickness and the plane directions.

The ratio of the first filler 2a having the orientation angle α of 30 degrees or more with respect to the plane direction SD of the thermal conductive sheet 1 is, for example, 17% or more, preferably 20% or more, or more preferably 25% or more, and usually is 100% or less with respect to the total amount of the first filler 2a in the conversion of number frequency.

When the ratio of the first filler 2a having the orientation angle α of 30 degrees or more is within the above-described range, an excellent thermal conductivity can be given to the thermal conductive sheet in the thickness direction.

The orientation angle α of the first filler 2a with respect to the thermal conductive sheet 1 is obtained as follows: the thermal conductive sheet 1 is cut out; sequentially transmitted images are photographed with an X-ray CT at an angle of 0 to 180 degrees; cross-sectional images are produced by reconstruction based on the entire transmitted images; the obtained images are analyzed to produce three-dimensional reconstructed images; and the calculation is performed based on the obtained images.

The thermal conductivity in the plane direction SD of the thermal conductive sheet 1 obtained in this way is 30 to 50 W/m·K, preferably 35 to 50 W/m·K, or more preferably 36 to 50 W/m·K.

The thermal conductivity in the plane direction SD of the thermal conductive sheet 1 is measured by a pulse heating method. In the pulse heating method, the xenonflash analyzer “LFA-447” (manufactured by Erich NETZSCH GmbH & Co. Holding KG) is used.

The thermal conductivity in the thickness direction TD of the thermal conductive sheet 1 is 4 to 15 W/m·K, preferably 7 to 15 W/m·K, or more preferably 10 to 15 W/m·K.

The thermal conductivity in the thickness direction TD of the thermal conductive sheet 1 is measured by a pulse heating method, a laser flash method, or a TWA method. In the pulse heating method, the above-described device is used, in the laser flash method, “TC-9000” (manufactured by Ulvac, Inc.) is used, and in the TWA method, “ai-Phase mobile” (manufactured by ai-Phase Co., Ltd) is used.

In the thermal conductive sheet 1, the filler 2 contains the plate-like or flake-like first filler 2a and the block-like or sphere-like second filler 2b, and the first filler 2a is contained so that the average orientation angle α₁ is 28 degrees or more and the maximum orientation angle α₂ is 60 degrees or more with respect to the plane direction SD of the thermal conductive sheet 1. Therefore, the thermal conductivity in the thickness direction TD and the plane direction SD of the thermal conductive sheet 1 can be ensured.

Thus, the thermal conductive sheet 1 has an excellent thermal conductivity in the thickness direction TD and plane direction SD. And in power electronics technology which uses semiconductor elements to convert and control electric power used in, for example, hybrid devices, high-brightness LED devices, and electromagnetic induction heating devices, the thermal conductive sheet 1 can be used as a heat dissipating member for converting a high current to heat or an insulating sheet. To be specific, for example, the thermal conductive sheet 1 can be preferably used as a heat dissipating member disposed near a semiconductor element used in a light emitting diode device, an imaging element used in an image-taking device, a back light of a liquid crystal display device, and furthermore, other various power modules for dissipating heat from the member, or as an insulating sheet disposed between the members for electrically insulating the members.

To be specific, for example, the thermal conductive sheet 1 is preferably used as a heat spreader or a heat sink of the light emitting diode device; a heat dissipating sheet attached to a casing of the liquid crystal display device or the image-taking device; or an encapsulating material for encapsulating an electronic circuit board.

### EXAMPLES

While the present invention will be described hereinafter in further detail with reference to Examples, the present invention is not limited to these Examples.

### Example 1

5.75 g of PT-110 (trade name, plate-like boron nitride particles, average particle size (light scattering method) of 35 to 60 μm, manufactured by Momentive Performance Materials Inc.) and 0.96 g of H-10 (trade name, block-like aluminum hydroxide particles, average particle size (light scattering method) of 55 μm, manufactured by Showa Denko K.K.) were prepared.

0.5 g of jER828 (trade name, bisphenol A epoxy resin, liquid, epoxy equivalent of 184 to 194 g/eqiv., softening temperature (ring and ball test) of less than 25° C., melt viscosity (80° C.) of 70 mPa·s, manufactured by Japan Epoxy Resins Co., Ltd.) and 1.0 g of EPPN-501HY (trade name, phenol epoxy resin, solid, epoxy equivalent of 163 to 175 g/eqiv., softening temperature (ring and ball test) of 57 to 63° C., manufactured by Nippon Steel Chemical Co., Ltd.) were dissolved in 2 g of solvent (acetone). Next, after 0.05 g of imidazole curing catalyst (curing agent) (2P4 MHZ-PW, manufactured by Shikoku Chemicals Corporation) was added thereto, the above-described PT-110 and H-10 were mixed and then dried at 60° C. for one hour to remove the solvent. Subsequently, the obtained powder was pressed and retained at a pressure of 10 MPa for 10 minutes with a pressing machine at 150° C. to cure a resin, so that a thermal conductive sheet was obtained.

### Example 2

A thermal conductive sheet was obtained in the same manner as in Example 1, except that H-10ME (trade name, block-like aluminum hydroxide particles, average particle size (light scattering method) of 100 μm, manufactured by Showa Denko K.K.) was used instead of H-10.

### Example 3

A thermal conductive sheet was obtained in the same manner as in Example 2, except that 4.79 g of PT-110 and 1.92 g of H-10ME were used.

### Example 4

A thermal conductive sheet was obtained in the same manner as in Example 2, except that 3.83 g of PT-110 and 2.88 g of H-10ME were used.

### Example 5

A thermal conductive sheet was obtained in the same manner as in Example 1, except that YSLV-80XY (trade name, naphthalene epoxy resin, solid, epoxy equivalent of 180 to 210 g/eqiv., softening temperature (ring and ball test) of 75 to 85° C., melt viscosity (150° C.) of 10 mPa·s or less, manufactured by Nippon Steel Chemical Co., Ltd.) was used instead of jER828.

### Example 6

A thermal conductive sheet was obtained in the same manner as in Example 1, except that AS-10 (trade name, sphere-like aluminum oxide (alumina) particles, average particle size (light scattering method) of 50 μm, manufactured by Showa Denko K.K.) was used instead of H-10.

### Comparative Example 1

A thermal conductive sheet was obtained in the same manner as in Example 1, except that 6.71 g of PT-110 was used without using H-10.

Evaluation

(1) Thermal Conductivity

The thermal conductivity in the thickness direction TD and the thermal conductivity in the plane direction SD of the thermal conductive sheets obtained in Examples and Comparative Example were measured by a pulse heating method using a xenon flash analyzer “LFA-447” (manufactured by Erich NETZSCH GmbH & Co. Holding KG). The results are shown in Table 1.

(2) Orientation Angle

The thermal conductive sheets obtained in Examples and Comparative Example were cut out to have a width of 2 mm and the cut-out pieces were fixed onto the specimen stage. Then, sequentially transmitted images were photographed with an X-ray CT every 0.2 degrees over an angle of 0 to 180 degrees. Next, cross-sectional images were produced by reconstruction based on the entire transmitted images and the obtained images were analyzed to produce three-dimensional reconstructed images. Thus, the orientation angles (the average orientation angle and the maximum orientation angle) and furthermore, the ratio of a first filler having the orientation angle of 30 degrees or more were measured. As an analysis software, ImageJ (developed at the National Institutes of Health (NIH)) was used. The results are shown in Table 1.

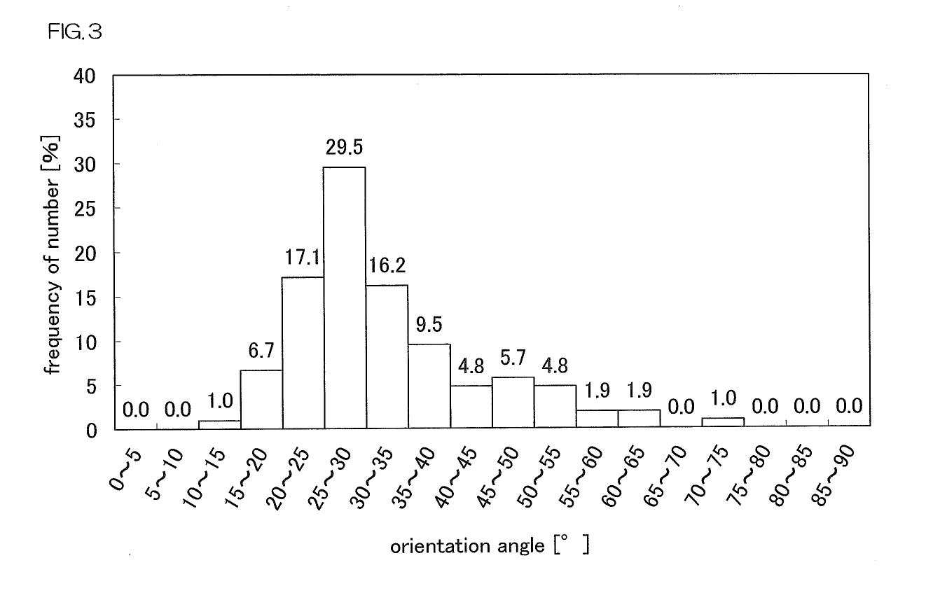

An X-ray CT image of the thermal conductive sheet of Example 1 is shown in FIG. 2. A histogram of an orientation angle obtained by analyzing the X-ray CT image is shown in FIG. 3.

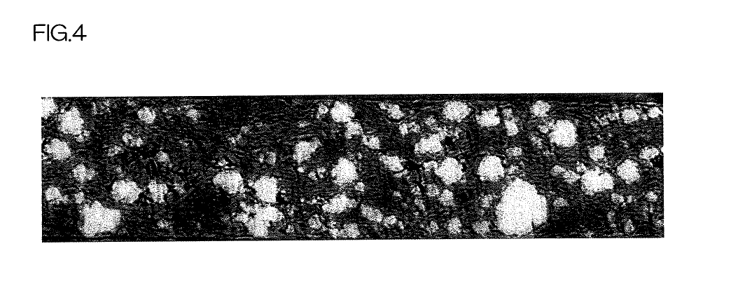

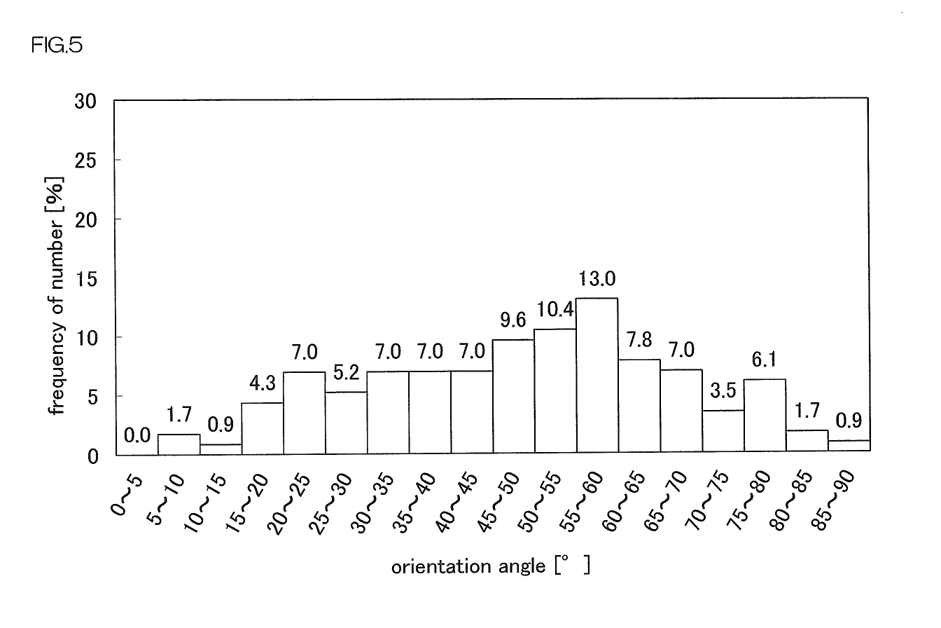

An X-ray CT image of the thermal conductive sheet of Example 4 is shown in FIG. 4. A histogram of an orientation angle obtained by analyzing the X-ray CT image is shown in FIG. 5.

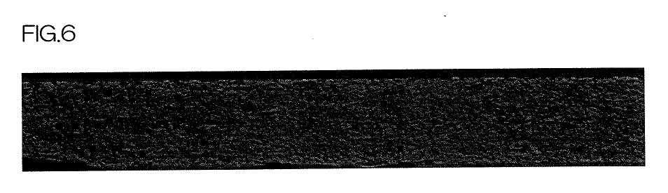

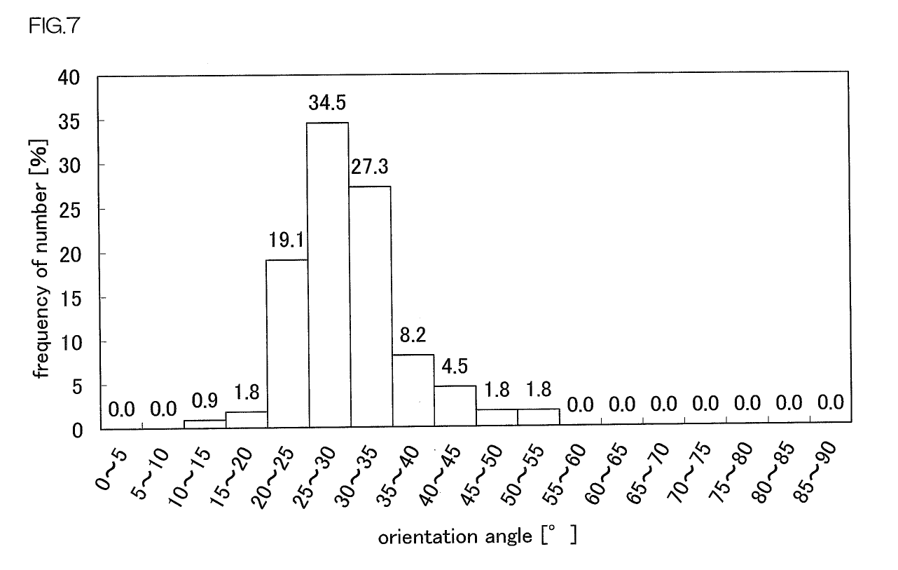

An X-ray CT image of the thermal conductive sheet of Comparative Example 1 is shown in FIG. 6. A histogram of an orientation angle obtained by analyzing the X-ray CT image is shown in FIG. 7.

TABLE 1

| | | | | | | | | | | Ratio |
|---|---|---|---|---|---|---|---|---|---|---|
| | | | | | | | | | | (number %) of |
| | | | | | | | | Orientation | | The First Filler |
| | | | | | | | | Angle α (degrees) of | | Having |
| Example | The First Filler | | The Second Filler | | Resin | Thermal Conductivity | | The First Filler | | Orientation |
| No./ | | Mixing | | Mixing | Mixing | (W/m · K) | | Average | Maximum | Angle of 30 |
| Comparative | | Amount | | Amount | Amount | Thickness | Plane | Orientation | Orientation | Degrees or |
| Example No. | Type | (g) | Type | (g) | (g) | Direction TD | Direction SD | Angle α₁ | Angle α₂ | More |
| Example 1 | PT110 | 5.75 | H-10 | 0.96 | 1.5 | 11.01 | 48.38 | 33 | 75 | 45.8 |
| Example 2 | PT110 | 5.75 | H-10ME | 0.96 | 1.5 | 11.76 | 43.67 | 37 | 87 | 53.6 |
| Example 3 | PT110 | 4.79 | H-10ME | 1.92 | 1.5 | 13.25 | 39.01 | 41 | 82 | 68.2 |
| Example 4 | PT110 | 3.83 | H-10ME | 2.88 | 1.5 | 12.46 | 36.44 | 48 | 87 | 81.0 |
| Example 5 | PT110 | 5.75 | H-10 | 0.96 | 1.5 | 10.45 | 48.82 | 32 | 74 | 45.5 |
| Example 6 | PT110 | 5.75 | AS-10 | 0.96 | 1.5 | 10.59 | 36.57 | 30 | 81 | 46.1 |
| Comparative | PT110 | 6.71 | — | — | 1.5 | 3.91 | 51.17 | 27 | 53 | 43.6 |
| Example 1 | | | | | | | | | | |

For the brevity codes used in Table 1, the details are given below.
PT-110: trade name, plate-like boron nitride particles, average particle size (light scattering method) of 45 μm, manufactured by Momentive Performance Materials Inc.
H-10: trade name, block-like aluminum hydroxide particles, average particle size (light scattering method) of 55 μm, manufactured by Showa Denko K.K.
H-10ME: trade name, block-like aluminum hydroxide particles, average particle size (light scattering method) of 100 μm, manufactured by Showa Denko K.K.
AS-10: trade name, sphere-like aluminum oxide (alumina) particles, average particle size (light scattering method) of 50 μm, manufactured by Showa Denko K.K.

While the illustrative embodiments of the present invention are provided in the above description, such is for illustrative purpose only and it is not to be construed as limiting the scope of the present invention. Modification and variation of the present invention that will be obvious to those skilled in the art is to be covered by the following claims.

What is claimed is:

1. A thermal conductive sheet comprising:
a resin and a filler, wherein
the filler comprising a plate-like or flake-like first filler and
a block-like or sphere-like second filler, and
the average orientation angle of the first filler is 28 degrees or more and
the maximum orientation angle thereof is 60 degrees or more with respect to the plane direction of the thermal conductive sheet.

2. The thermal conductive sheet according to claim 1, wherein
the ratio of the first filler having an orientation angle of 30 degrees or more with respect to the plane direction of the thermal conductive sheet is 20% or more with respect to the total amount of the first filler in the conversion of number frequency.

3. The thermal conductive sheet according to claim 1, wherein
the first filler has an average particle size of 30 to 100 μm and
the second filler has an average particle size of 20 to 80 μm, and
the first filler content is 30 to 95 parts by mass and the second filler content is 5 to 70 parts by mass with respect to 100 parts by mass of the total amount of the first filler and the second filler.

4. The thermal conductive sheet according to claim 1, wherein
the filler content is 50 to 95 parts by mass with respect to 100 parts by mass of the total amount of the thermal conductive sheet.

5. An insulating sheet being obtained by using a thermal conductive sheet, wherein
the thermal conductive sheet comprising a resin and a filler;
the filler comprising a plate-like or flake-like first filler and
a block-like or sphere-like second filler; and
the average orientation angle of the first filler is 28 degrees or more and
the maximum orientation angle thereof is 60 degrees or more with respect to the plane direction of the thermal conductive sheet.

6. A heat dissipating member being obtained by using a thermal conductive sheet, wherein
the thermal conductive sheet comprising a resin and a filler;
the filler comprising a plate-like or flake-like first filler and
a block-like or sphere-like second filler; and
the average orientation angle of the first filler is 28 degrees or more and
the maximum orientation angle thereof is 60 degrees or more with respect to the plane direction of the thermal conductive sheet.
